(19) United States
(12) Patent Application Publication
(10) Pub. No.: US 2025/0358558 A1
(43) Pub. Date: Nov. 20, 2025

(54) CEILING MOUNTABLE SPEAKER ENCLOSURE

(71) Applicant: Atlas Sound LP, Phoenix, AZ (US)

(72) Inventors: Johnathan Ivey, Chandler, AZ (US); Kim Porter Henneman, Anthem, AZ (US); Jordane Giovannone Raub, Mesa, AZ (US); Stuart Thomas Wilkinson, COATBRIDGE SCOTLAND (GB); Kevin Sykes, Portland, OR (US)

(73) Assignee: Atlas Sound LP, Phoenix, AZ (US)

(21) Appl. No.: 18/665,952

(22) Filed: May 16, 2024

(51) Int. Cl. H04R 1/02

(52) U.S. Cl. CPC H04R 1/026; H04R 1/025; H04R 2201/021

(57) ABSTRACT

A ceiling mountable speaker enclosure includes a speaker support at least partially defining the speaker enclosure and including a mounting flange. The mounting flange defines flange openings that extend therethrough. A clamp assembly includes a clamp foot and an actuator rod having a first end engageable with the clamp foot and a second end including a handle. The handle includes a resilient seal and is operable to afford movement of the clamp foot relative to the mounting flange to secure the speaker enclosure within a panel. The handle has a stowed position in which the seal engages the mounting flange to cover and seal the plurality of flange openings. While in the stowed position the handle may also engage a release lever to prevent unwanted operation of the release lever that might otherwise loosen the speaker enclosure from the panel into which it is installed.

### TECHNICAL FIELD

This disclosure relates to providing an improved rapidly mountable ceiling speaker enclosure. In particular, this disclosure relates to providing a manually installable ceiling speaker that includes resilient securement and sealing features to, among other things, improve thermal management, reduce undesired vibration, provide for an enlarged speaker enclosure volume, and permit installation of the speaker enclosure in a wider variety of ceiling types.

### BACKGROUND

Installation of loudspeakers into panels, especially ceiling panels, presents unique challenges, especially in obtaining the desired balance between speed of installation and security of installation. Significantly, ceiling speaker installation in larger buildings can involve a thousand or more ceiling speakers, and the time it takes to install one ceiling speaker, multiplied a thousand times, becomes a noticeable factor in labor costs. A general class of devices used for ceiling speaker installation are “flip out dog legs” which clamp, or dog, a peripheral portion of ceiling panel between an annular flange and at least two dogs which are mounted peripherally around the speaker enclosure. In this regard the flip out dog legs function as clamps or clamping members to secure the speaker enclosure within the ceiling. These clamps are initially retracted within the outer circumference of the hole in the ceiling panel in which the loudspeaker enclosure is to be mounted. In conventional operation, a screw device or cam arrangement is used to “flip” the dog into a radially aligned position and lower the dog to the clamping position. This may be accomplished using a screwdriver or by using a pull-down mechanism that includes a ratcheting arrangement that secures the dog in the lowered clamping position.

U.S. Pat. No. 9,729,952, the entire contents of which are hereby incorporated by reference herein, discloses a toolless ceiling speaker enclosure that has a biased sliding ratchet block that can be latched in place by an extension from a T-handle of an integral actuator rod. The T-handle includes a latch that, along with the actuator rod, extends through perforations in an annular support panel of the enclosure. These perforations may permit air to flow between the area above the annular support panel and the area below the annular support panel.

### SUMMARY

Hereinafter, the term “speakers” is used to mean “audio loudspeakers”. The apparatus of the present invention provides a mountable speaker enclosure, with or without one or more speakers, that includes an integrated mounting actuator, such as a retainable handle. The system comprises movable clamps for clamping an inserted speaker enclosure to the periphery of a ceiling panel into which the speaker enclosure has been inserted. The system may also include a handle that includes integrated sealing elements to seal openings in the enclosure that might otherwise permit air flow between one side of the enclosure and an opposite side of the enclosure. The system may also include interchangeable resilient clamp feet that may be coupled to the clamps to permit installation of the enclosure into ceiling panels of varying thicknesses.

In some aspects, a ceiling mountable speaker enclosure includes a speaker support at least partially defining the speaker enclosure and including a mounting flange extending outwardly from the speaker support. The mounting flange defines an outwardly facing side, an inwardly facing side, and a plurality of flange openings extending through the mounting flange and affording fluid communication between the inwardly facing side and the outwardly facing side. A clamp assembly is coupled to the mounting flange and includes a clamp foot and an actuator rod having a first end engageable with the clamp foot and a second end including a handle. The handle includes a resilient seal and is operable to afford movement of the clamp foot relative to the mounting flange. The handle has a stowed position in which the resilient seal engages the mounting flange to limit fluid communication via the plurality of flange openings between the inwardly facing side and the outwardly facing side of the mounting flange.

In other aspects, the mounting flange may define a recess that opens toward the outwardly facing side, the plurality of flange openings may be positioned within the recess, and when the handle is in the stowed position the handle may be at least partially received within the recess. The recess may define a perimeter wall having a first perimeter profile, and the resilient seal may have a second perimeter profile that corresponds to the first perimeter profile such that when the handle is in the stowed position the resilient seal is compressed against the perimeter wall. The handle may be operable to afford movement of the clamp foot from a disengaged position to an engaged position, and when the handle is moved to the stowed position the clamp foot may remain in the engaged position. The clamp assembly may include a release lever that may be operable to release the clamp foot for movement from an engaged position toward a disengaged position, and the release lever may extend from the inwardly facing side through one of the plurality of flange openings to the outwardly facing side. The handle may define a handle opening, and the resilient seal may extend into and surround the handle opening, and when the handle is in the stowed position the release lever may extend into the handle opening and engage the resilient seal to limit fluid communication through the handle opening. When the handle is in the stowed position, the handle may engage the release lever to prevent operation of the release lever.

In other aspects, the speaker support may include a speaker assembly, and the speaker enclosure may further comprise an outer housing into which the speaker support may be removably installable. When the speaker support is installed within the outer housing, the mounting flange and the clamp foot may cooperate to secure the speaker support within the outer housing, and the outer housing, the speaker support, the speaker assembly, the handle, and the resilient seal may cooperate to define a speaker enclosure volume. When the speaker support is installed within the outer housing the clamp foot may be located inside the speaker enclosure volume.

In other aspects, the clamp foot may include an arm having a top surface and a first contact surface spaced a first distance from the top surface. The speaker enclosure may further comprise a clamp foot extension that may be detachably securable to the clamp foot and that may have a second contact surface. When the clamp foot extension is secured to the clamp foot the second contact surface may be spaced a second distance from the top surface that is greater than the first distance.

In some aspects, a ceiling mountable speaker enclosure includes a speaker support at least partially defining the speaker enclosure and including a speaker assembly and a mounting flange extending outwardly from the speaker support. The mounting flange defines an outwardly facing side, an inwardly facing side, and a flange opening extending through the mounting flange and affording fluid communication between the inwardly facing side and the outwardly facing side. A clamp assembly is coupled to the mounting flange and includes a clamp foot and an actuator rod having a first end engageable with the clamp foot and a second end including a handle. The handle includes a resilient seal and is operable to afford movement of the clamp foot relative to the mounting flange. The handle has a stowed position in which the resilient seal engages the mounting flange to limit fluid communication via the flange opening between the inwardly facing side and the outwardly facing side of the mounting flange. The ceiling mountable speaker enclosure also includes an outer housing into which the speaker support is removably installable, and when the speaker support is installed within the outer housing, the mounting flange and the clamp foot cooperate to secure the speaker support within the outer housing, and the outer housing, the speaker support, the speaker assembly, the handle, and the resilient seal cooperate to define a speaker enclosure volume.

In other aspects, the outer housing may include hanger brackets for supporting the outer housing, and electrical terminals for electrically connecting the outer housing to an audio source, and when the speaker support is installed within the outer housing, the hanger brackets and electrical terminals may be located outside of the speaker enclosure volume. When the speaker support is installed within the outer housing the clamp foot may be positioned inside the speaker enclosure volume. The mounting flange may define a recess that opens toward the outwardly facing side, the flange opening may be positioned within the recess, and when the handle is in the stowed position the handle may be at least partially received within the recess. The recess may define a perimeter wall having a first perimeter profile, and the resilient seal may have a second perimeter profile that corresponds to the first perimeter profile such that when the handle is in the stowed position the resilient seal may be compressed against the perimeter wall.

In some aspects, a ceiling mountable speaker enclosure includes a speaker support at least partially defining the speaker enclosure and including a mounting flange extending outwardly from the speaker support. The mounting flange defines an outwardly facing side, an inwardly facing side, and a plurality of flange openings extending through the mounting flange and affording fluid communication between the inwardly facing side and the outwardly facing side. The ceiling mountable speaker enclosure also includes a clamp assembly coupled to the mounting flange and including a clamp foot and an actuator rod having a first end engageable with the clamp foot and a second end including a handle. The handle includes a resilient seal and is operable to afford movement of the clamp foot relative to the mounting flange from a disengaged position toward an engaged position. The handle has a stowed position in which the resilient seal engages the mounting flange to limit fluid communication via the plurality of flange openings between the inwardly facing side and the outwardly facing side of the mounting flange. The clamp assembly further includes a release lever that is operable to release the clamp foot for movement from the engaged position toward the disengaged position. The release lever extends from the inwardly facing side through one of the plurality of flange openings to the outwardly facing side.

In other aspects, the mounting flange may define a recess that opens toward the outwardly facing side, the plurality of flange openings may be positioned within the recess, and when the handle is in the stowed position the handle may be at least partially received within the recess. The recess may define a perimeter wall having a first perimeter profile, and the resilient seal may have a second perimeter profile that may correspond to the first perimeter profile such that when the handle is in the stowed position the resilient seal may be compressed against the perimeter wall. The handle may define a handle opening, the resilient seal may extend into and surround the handle opening, and when the handle is in the stowed position the release lever may extend into the handle opening and engage the resilient seal to limit fluid communication through the handle opening. When the handle is in the stowed position, the handle may engage the release lever to prevent operation of the release lever.

In other aspects, the speaker support may include a speaker assembly, and the speaker enclosure may further include an outer housing into which the speaker support may be removably installable. When the speaker support is installed within the outer housing, the mounting flange and the clamp foot may cooperate to secure the speaker support within the outer housing, the outer housing, the speaker support, the speaker assembly, the handle, and the resilient seal may cooperate to define a speaker enclosure volume, and at least the clamp foot of the clamp assembly may be located inside the speaker enclosure volume.

While the exemplary disclosure is described and illustrated with respect to speaker enclosures, the scope of the present disclosure also includes enclosures for lighting fixtures, such as can lights, or any other device that needs to be supported in an enclosure in a ceiling or wall.

### BRIEF DESCRIPTION OF DRAWINGS

FIG. 1 is a top perspective view of a ceiling mountable speaker enclosure.

FIG. 2 is a bottom perspective view of the ceiling mountable speaker enclosure of FIG. 1.

FIG. 3 is a top view of the ceiling mountable speaker enclosure of FIG. 1

FIG. 4 is a side view of a clamp foot of the ceiling mountable speaker enclosure of FIG. 1

FIG. 5 is a side view of the clamp foot of FIG. 4 with a clamp foot extension secured thereto.

FIG. 6 is an enlarged perspective view showing a clamp assembly of the ceiling mountable speaker enclosure of FIG. 1.

FIG. 7 is an enlarged section view taken along line 7-7 of FIG. 3.

FIG. 8 is an enlarged perspective view showing the encircled portion A of FIG. 1.

FIG. 9 is a perspective view of an actuator rod and handle of the ceiling mountable speaker enclosure of FIG. 1.

FIG. 10 is a perspective view of an alternative configuration of a ceiling mountable speaker enclosure.

FIG. 11 is a side view of the ceiling mountable speaker enclosure of FIG. 10.

FIG. 12 is a section view taken along line 12-12 of FIG. 11.

Before any exemplary configurations of the disclosure are explained in detail, it is to be understood that the disclosure is not limited in its application to the details of construction and the arrangement of components set forth in the following description or illustrated in the accompanying drawings. The disclosure is capable of other configurations and of being practiced or of being carried out in various ways. Also, it is to be understood that the phraseology and terminology used herein is for the purpose of description and should not be regarded as limiting.

### DETAILED DESCRIPTION

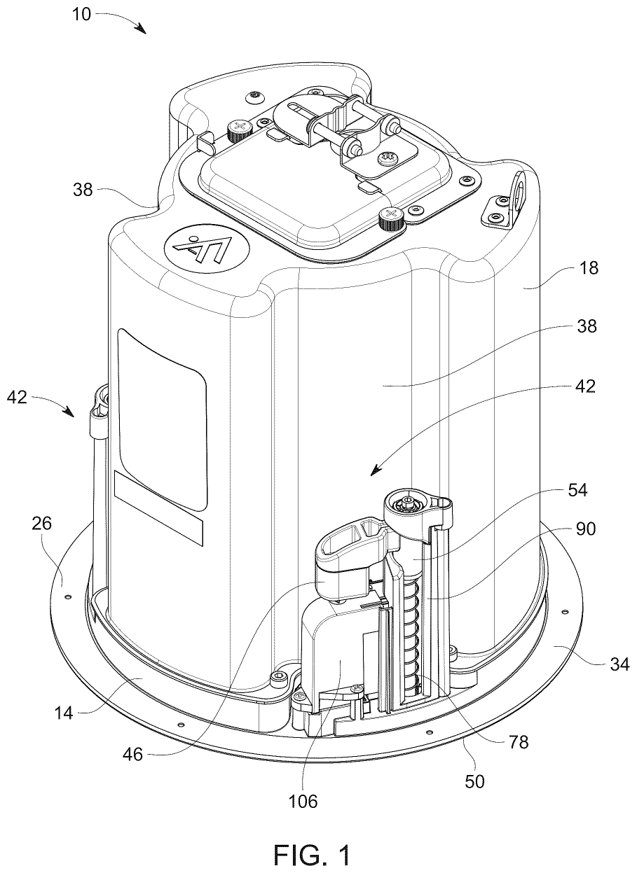

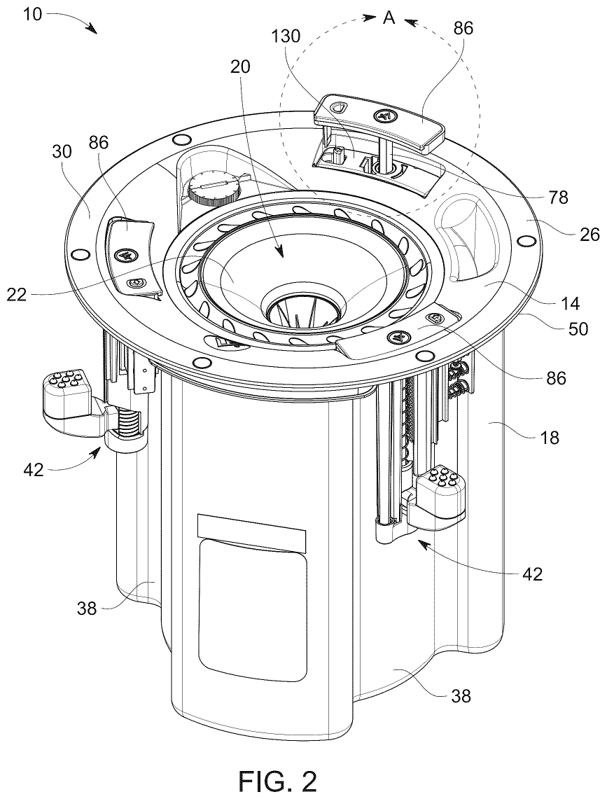

FIGS. 1-3 illustrate a ceiling mountable speaker enclosure 10 for mounting within an opening provided in a ceiling, wall, or similar structural panel. The speaker enclosure 10 includes a speaker support 14 that defines a speaker can 18 and supports a speaker assembly 20. The speaker assembly 20 includes a diaphragm 22 (FIG. 2) and a driver (not shown), and may be electrically connected to an audio signal source for the reproduction of sound. As used herein, directional modifiers such as “top”, “bottom”, “up”, “down”, and the like are with respect to a ceiling installation application of the speaker enclosure 10 in which the diaphragm 22 points in a downward direction from the ceiling. Those of skill in the art, informed by the present disclosure, will appreciate that the enclosure 10 can also be mounted in walls or other structural panels, including slanted walls or panels.

The speaker support 14 of FIGS. 1-3 includes a radially outwardly extending mounting flange 26 configured for mating engagement with the panel into which the enclosure 10 is installed. The mounting flange 26 includes an outwardly facing side 30 that faces downwardly when the enclosure 10 is installed in a ceiling panel, and an inwardly facing side 34 that faces upwardly when the enclosure 10 is installed in a ceiling panel. The illustrated speaker can 18 is generally cylindrical but with a plurality of recessed side portions 38, each of which is configured to receive a clamp assembly 42 that is coupled to the inwardly facing side 34 of the mounting flange 26. The size and configuration of the speaker can 18 may be selected by the designer to provide a desired speaker enclosure volume that compliments the characteristics of the speaker assembly 20.

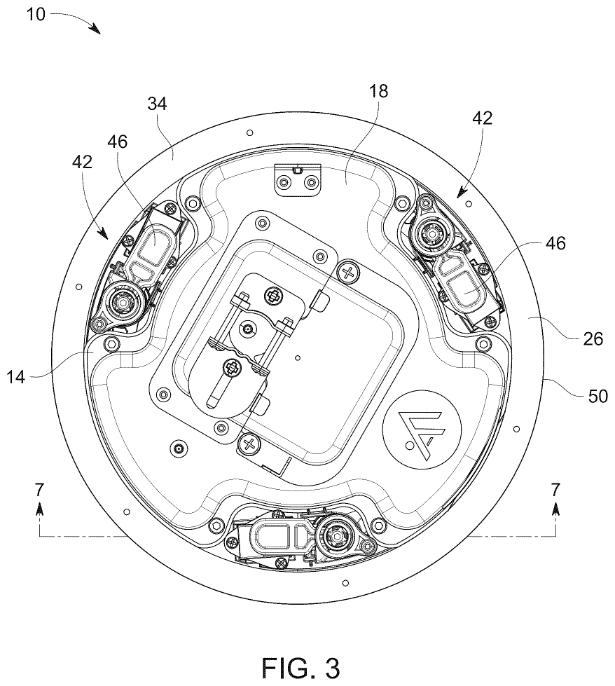

The clamp assemblies 42 are configured to secure the speaker enclosure 10 to the ceiling panel. While the illustrated enclosure includes three clamp assemblies 42 more or fewer clamp assemblies may be used depending on the particulars of a given application. Each clamp assembly 42 includes a clamp foot 46 that is moveable between a retracted position (illustrated in FIGS. 1 and 3) in which the clamp foot 46 is positioned within an imaginary cylinder defined by an outer perimeter 50 of the mounting flange 26, a disengaged position (illustrated in FIG. 2) in which at least a portion of the clamp foot 46 extends outside the imaginary cylinder defined by the outer perimeter 50 of the mounting flange 26, and an engaged position (illustrated in FIG. 12) in which the clamp foot 46 is lowered relative to the mounting flange 26 to secure the enclosure 10 within the panel into which it is installed.

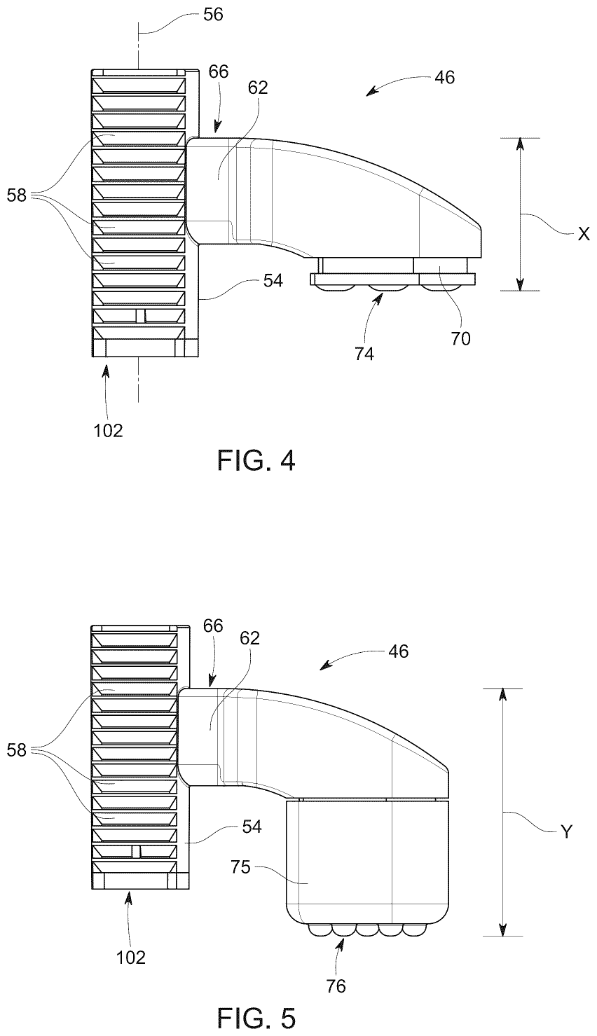

Referring also to FIG. 4, each clamp foot 46 includes a hollow barrel portion 54 defining a barrel axis 56 and having a plurality of ratchet teeth 58 along a side portion thereof. As discussed further below, the ratchet teeth 58 help to secure the clamp foot 46 in the engaged position. Each clamp foot 46 also includes an arm 62 extending radially away from the barrel portion 54 and defining a top surface 66. A distal end of the arm 62 is provided with a resilient contact pad 70 that defines a first contact surface 74. The first contact surface 74 is spaced an axial distance X from the top surface 66 and is adapted for engagement with the inner surface of the structural panel into which the enclosure 10 is installed. The contact pad 70 and first contact surface 74 may be formed of a resilient material that provides a relatively high coefficient of friction, such as one or more rubbers, silicones, thermoplastic elastomers, thermoplastic polyurethanes, and the like.

FIG. 5 illustrates the clamp foot 46 with an optional clamp foot extension 75 attached thereto. The upper portion of the clamp foot extension 75 is configured to be detachably securable to the resilient contact pad 70 of the clamp foot 46 while the lower portion of the clamp foot extension 75 defines a second contact surface 76. Like the contact pad 70, the clamp foot extension 75 may be formed of a resilient material that provides a relatively high coefficient of friction, and in some configurations may be formed of the same material as the contact pad 70. In the illustrated configuration the upper portion of the clamp foot extension 75 is deformable to facilitate attachment to the contact pad 70. In other configurations the clamp foot extension 75 may be secured to the contact pad using a combination of adhesives, fasteners, and the like. When the clamp foot extension 75 is attached to the clamp foot 46, the second contact surface 76 is spaced an axial distance Y from the top surface 66 of the arm 62. The axial distance Y is greater than the axial distance X between the top surface 66 and the first contact surface 74. The clamp foot extension 75 allows the enclosure 10 to be installed into panels having a greater range of panel thicknesses. For example, when installing the enclosure 10 into panels that are thicker than a threshold thickness, the clamp foot extension 75 would not be used. However, with the clamp foot extension 75 attached to the clamp foot 46, the enclosure can be installed into panels that are thinner than the threshold thickness.

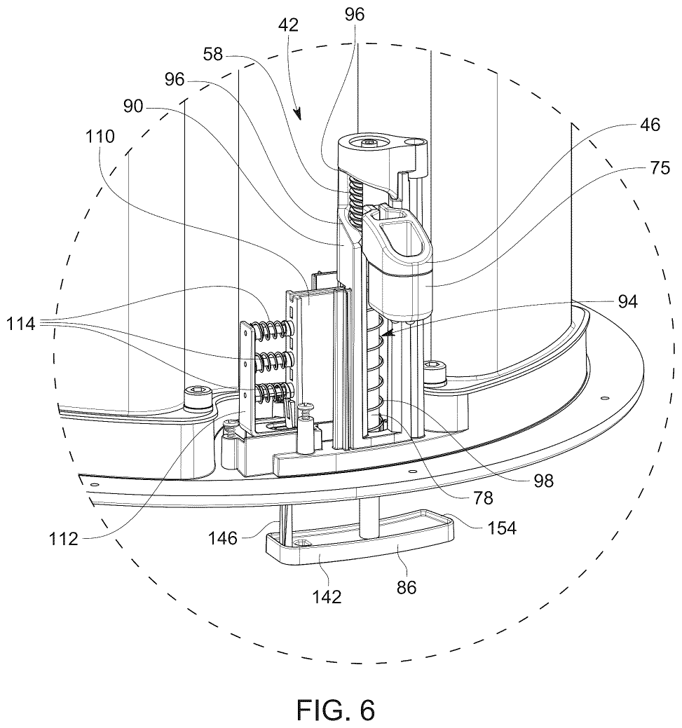

Referring also to FIGS. 6-9, each clamp assembly 42 includes an actuator rod 78 having a first end 80 that, in the illustrated configuration, extends through and is selectively engageable with the barrel portion 54 of the clamp foot 46. A second end 82 of the actuator rod is coupled to a handle 86 that is operable to afford movement of the clamp foot 46 relative to the mounting flange 26. More specifically, in the illustrated configuration the handle 86 is operable to move the clamp foot 46 between the retracted and disengaged positions and from the disengaged position to the engaged position. In some configurations the handle 86 may be integrally formed with the second end 82 of the actuator rod 78, while in other configurations the handle 86 may be separately formed and secured to the actuator rod 78 using a suitable method of attachment, including but not limited to fasteners, adhesives, welding, brazing, press fit, or the like, such that rotation of the handle 86 causes rotation of the actuator rod 78. In the illustrated configuration the first end 80 includes a plurality of radially outwardly extending projections 87 adapted to fit within corresponding recesses in the upper end of the barrel portion 54. When the projections 87 are received within the recesses of the barrel portion 54, rotation of the handle 86 causes rotation of the clamp foot 46, and downward movement of the handle 86 causes downward movement of the clamp foot 46.

The actuator rod 78 extends through an actuator opening 88 defined by the mounting flange 26 and is positioned and arranged such that the first end 80 and clamp foot 46 are on the inwardly facing side 34 of the mounting flange 26 and the second end 82 and handle 86 are on the outwardly facing side 30 of the mounting flange 26. The actuator opening 88 therefore provides fluid communication through the mounting flange 26 between the inwardly facing side 34 and the outwardly facing side 30.

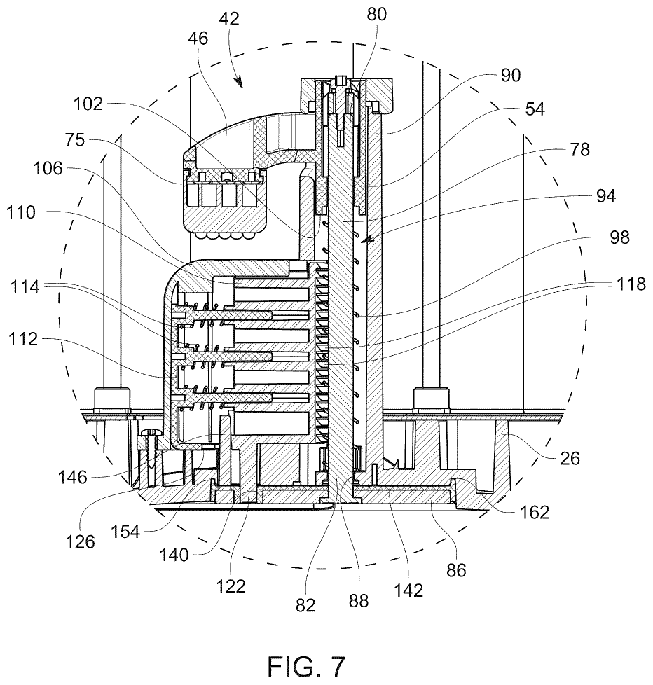

Each clamp assembly 42 also includes a barrel guide portion 90 that slidably receives the barrel portion 54 of the clamp foot 46. The barrel guide portion 90 defines a guide chamber 94 along which the barrel portion 54 of the clamp foot 46 can slide. In addition, the barrel guide portion 90 includes cam surfaces 96 that guide movement of the clamp foot 46 such that when the barrel portion 54 is located at an upper end of the barrel guide portion 90, the clamp foot 46 is moved to the retracted position, and as the barrel portion 54 moves downwardly in the barrel guide portion 90 the cam surfaces 96 rotate the clamp foot to the disengaged position. The barrel guide portion 90 also functions as a housing for a coil spring 98 that biases the clamp foot 46 from the engaged position toward the disengaged position (e.g. upwardly in FIGS. 6 and 7). More specifically, the coil spring 98 is positioned between the mounting flange 26 and a bottom surface 102 of the barrel portion 54 of the clamp foot 46. In the illustrated configuration the barrel guide portion 90 is integrally formed with the mounting flange 26, it should be appreciated however that in other configurations the barrel guide portion 90 may be separately formed and attached to the mounting flange 26 using suitable fasteners, adhesives, sonic welding, or the like.

Each clamp assembly 42 also includes a ratchet housing 106 (see FIG. 1) positioned adjacent to the barrel guide portion 90. The ratchet housing 106 houses and guides movement of a ratchet block 110 that operates to secure the clamp foot 46 in the engaged position. With reference to FIG. 6, in which the ratchet housing 106 has been removed to reveal the underlying structure, a bracket 112 coupled to the mounting flange 26 supports a plurality of springs 114 that bias the ratchet block 110 toward the guide chamber 94 of the barrel guide portion 90. The ratchet block 110 includes a plurality of ratchet teeth 118 that extend into the guide chamber 94. As the clamp foot 46 is moved from the disengaged position to the engaged position, the ratchet teeth 58 of the barrel portion 54 move into engagement with the ratchet teeth 118 of the ratchet block 110, at which point the ratchet teeth 118, under the biasing influence of the springs 114, resist the upward biasing force of the coil spring 98 to secure the clamp foot 46 in the engaged position.

The ratchet block 110 also includes a release lever 122 that extends generally downwardly from the ratchet block 110 and through a release opening 126 that is defined by the mounting flange 26 and that provides fluid communication through the mounting flange 26 between the inwardly facing side 34 and the outwardly facing side 30. The release lever 122 extends through the release opening 126 from the inwardly facing side 34 of the mounting flange 26 to the outwardly facing side 30 of the mounting flange 26. The release lever 122 is manually operable from the outwardly facing side 30 of the mounting flange 26 to move the ratchet block 110 against the biasing force provided by the springs 114 (e.g. to the left in FIG. 7) and to thereby disengage the ratchet teeth 118 of the ratchet block 110 from the ratchet teeth 58 of the barrel portion 54. When the ratchet teeth 118 are disengaged from the ratchet teeth 58, the coil spring 98 moves the clamp foot 46 from the engaged position toward the disengaged position.

As best shown in FIGS. 2, 7, and 8, the outwardly facing side 30 of the mounting flange 26 defines a recess 130 that is adapted and configured to receive the handle 86 when the handle 86 is in a stowed position. The recess 130 opens toward the outwardly facing side 30 and, in the illustrated configuration, both the actuator opening 88 and the release opening 126 are positioned within the recess 130. The recess 130 is defined by a perimeter wall 134 having a first perimeter profile that corresponds to a second perimeter profile defined by the handle 86 such that the recess 130 receives the handle 86 when the handle 86 is moved to the stowed position.

More specifically, the handle 86 includes a flat, relatively rigid handle base 138 coupled to the actuator rod 78. The handle base 138 defines a handle opening 140 that is sized and positioned to receive the release lever 122 of the ratchet block 110 when the handle 86 is in the stowed position. The handle base 138 also includes a locking tang 146 positioned adjacent to the handle opening 140 and extending in an upward direction generally parallel to the actuator rod 78. The locking tang 146 is sized and positioned such that when the handle 86 is in the stowed position the locking tang 146 extends through the release opening 126 and into a position between the mounting flange 26 and the release lever 122. With the locking tang 146 so positioned, the locking tang 146 can block movement of the release lever 122 in a releasing direction (e.g. to the left in FIG. 7), which would otherwise result in disengagement of the ratchet teeth 118 from the ratchet teeth 58 and movement of the clamp foot 46 from the engaged position toward the disengaged position. Accordingly, with the handle 86 in the stowed position the handle 86 engages the release lever 122 to prevent operation of the release lever 122. More specifically, both the opening 140 and the locking tang 146 of the handle engage the release lever 122 to prevent undesired movement of the release lever 122 that might otherwise result in movement of the clamp foot 46 and loosening of the speaker enclosure 10 from the panel into which it is installed.

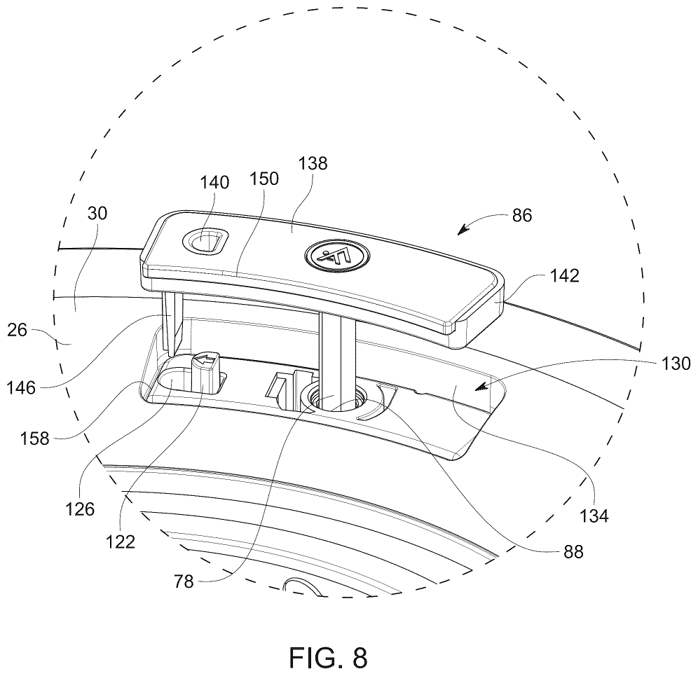

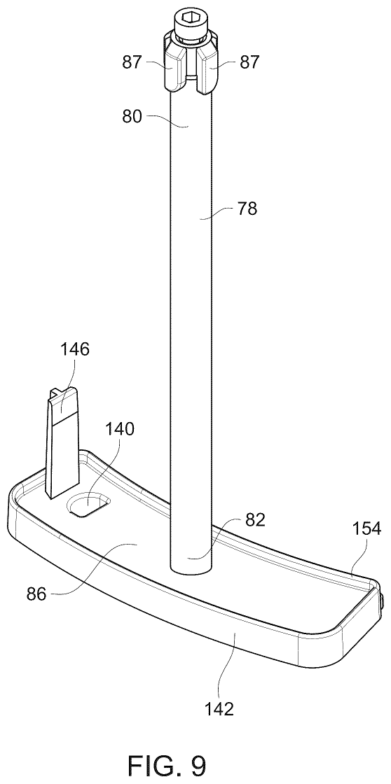

The illustrated handle 86 also includes a resilient seal 142 coupled to the handle base 138. In the illustrated configuration the seal 142 covers most of the underside of the handle base 138 except for an inner lip portion 150 that projects slightly outside of the recess 130 when the handle 86 is in the stowed position to facilitate manual extraction of the handle 86 from the recess 130. The seal 142 defines the above-described second perimeter profile of the handle 86 that corresponds to the first perimeter profile defined by the perimeter wall 134 of the recess 130. When the handle 86 is pushed into the recess 130 toward the stowed position, the outer perimeter of the seal 142 compresses against the perimeter wall 134 to provide a smooth, high quality, tactile feel as the handle 86 fully seats into the recess 130 and arrives at the stowed position. In addition, a perimeter ridge 154 (FIGS. 6 and 9) of the seal 142 seats into a corresponding valley 158 (FIG. 8) that is formed along the outer perimeter of the recess 130 to define a serpentine sealing interface 162 (FIG. 7) that further enhances the sealing ability of the seal 142. In the illustrated configuration, the seal 142 also extends into and surrounds the handle opening 140 so that as the release lever 122 enters the handle opening 140 as the handle 86 is moved to the stowed position, the seal 142 engages the release lever 122 to limit fluid communication through the handle opening 140 when the handle 86 is in the stowed position.

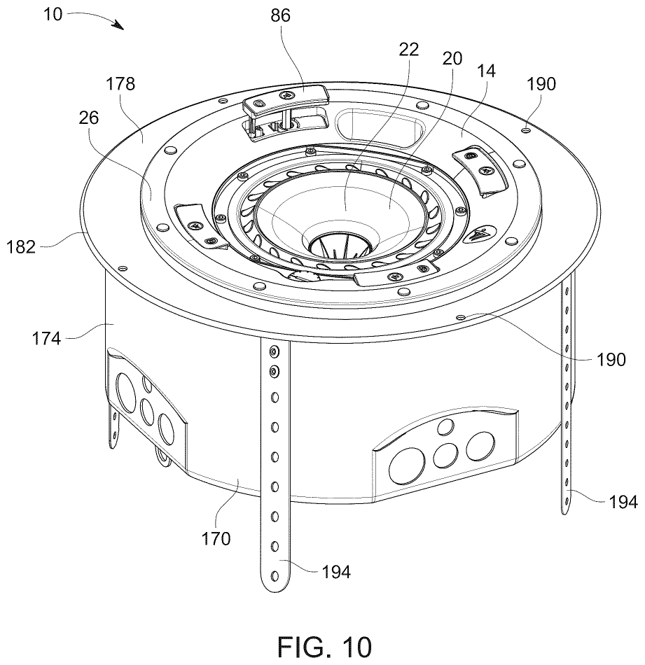

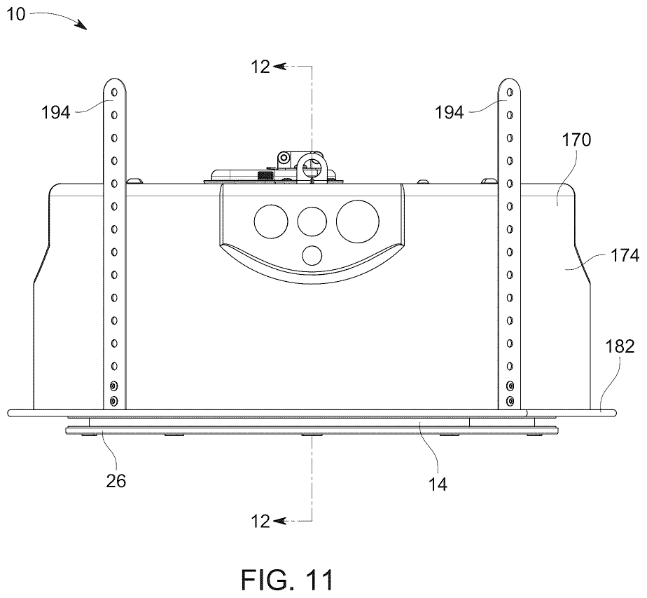

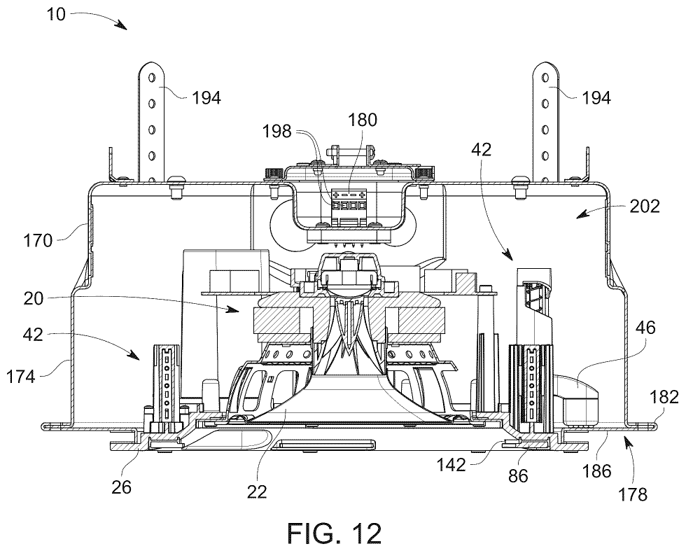

The snug, sealing engagement between the seal 142 and the recess 130 when the handle 86 is in the stowed position provides a high-quality tactile feel during installation of the enclosure 10 into the ceiling panel. The snug, sealing engagement also reduces rattling of the handle 86 and the actuator rod 78 during operation of the speaker assembly 20, thereby improving overall sound quality. The snug, sealing engagement also limits fluid communication between the inwardly facing side 34 and the outwardly facing side 30 of the mounting flange 26 via the actuator opening 88, via the release opening 126, and via other openings that may be present in the recess 130. By limiting such fluid communication, the thermal performance of the ceiling panel into which the enclosure 10 is installed can be improved and, as discussed further below with respect to FIGS. 10-12, a speaker enclosure having a relatively larger sealed or ported speaker enclosure volume may be provided to enhance performance of the speaker assembly 20.

In the illustrated construction, the seal 142 of the handle 86 is formed as a single continuous piece by over-molding a resilient material, which may be or include one or more rubbers, silicones, thermoplastic elastomers, thermoplastic polyurethanes, and the like, onto the handle base 138. It should be appreciated however that the seal 142 could be formed as multiple parts using other manufacturing techniques, and may incorporate other attachment methods such as adhesives, grooves, ridges, fasteners, and the like, alone or in combination.

To install the speaker enclosure 10 into a ceiling panel, with the clamp feet 46 in their retracted positions, the speaker can 18 is inserted into the ceiling panel opening until the inwardly facing side 34 of the mounting flange 26 abuts the ceiling panel. Each handle 86 is then pulled downwardly against the resistance provided by the coil spring 98, which also moves the respective clamp foot 46 downwardly within the guide chamber 94. Due to interaction of the clamp foot 46 with the cam surfaces 96, downward movement of the handle 86 and clamp foot 46 rotates the clamp foot 46 from the retracted position to the disengaged position, which may also rotate the handle 86 into an orientation substantially aligned with the recess 130. The handle 86 is then further pulled downwardly to move its respective clamp foot 46 toward the engaged position until the resilient contact pad 70 or the clamp foot extension 75, if installed, contacts the ceiling panel and clamps the ceiling panel between the first contact surface 74 or, if the clamp foot extension 75 is installed, the second contact surface 76, and the mounting flange 26. As each clamp foot 46 approaches the engaged position, the ratchet teeth 118 of the ratchet block 110 are urged into engagement with the ratchet teeth 58 of the barrel portion 54 by the springs 114 to secure the clamp foot 46 in the engaged position. By pulling firmly down on the handles 86 the contact pads 70 or clamp foot extensions 75, if installed, may be compressed against the panel to firmly secure the enclosure 10 in the opening.

With the clamp feet 46 in their engaged positions the handles 86 may be returned to their stowed positions by pushing them upwardly toward the recesses 130 to disengage the projections 87 at the upper end of the actuator rod 78 from the barrel portions 54 of the corresponding clamp feet 46, thereby allowing the handles 86 to move axially and rotationally relative to the clamp feet 46 without disengaging the clamp feet 46 from the panel. As each handle 86 approaches its stowed position and enters its respective recess 130, the outer perimeter of the seal 142 compresses against the perimeter wall 134 of the recess 130 and the perimeter ridge 154 of the seal 142 seats into the valley 158 of the recess 130 to form the serpentine sealing interface 162. In addition, the locking tang 146 enters the release opening 126 and the release lever 122 enters the handle opening 140, both of which serve to prevent unwanted movement of the release lever 122 and disengagement of the ratchet teeth 54 and 118.

To remove the speaker enclosure 10 from the panel, the inner lip portion 150 of each handle 86 may be grasped or otherwise engaged by a tool or fingertip and the handle 86 may be pulled downwardly to remove it from its respective recess 130, thereby exposing the release lever 122 and withdrawing the locking tang 146 from the release opening 126 to allow movement of the release lever 122. The release lever 122 is then moved in a disengaging direction (e.g. to the left in FIG. 7 and in the direction of the arrow in FIG. 8) to release the clamp foot 46 for movement from the engaged position to the disengaged position. More specifically, movement of the release lever 122 in the disengaging direction slides the ratchet block 110 within the ratchet housing 106 against the biasing force provided by the springs 114 to disengage the ratchet teeth 118 of the ratchet block 110 from the ratchet teeth 58 of the barrel portion 54 of the clamp foot 46. Disengagement of the ratchet teeth 118 from the ratchet teeth 58 releases the clamp foot 46 for movement within the barrel guide portion 90 under the influence of the coil spring 98, which urges the clamp foot 46 from the engaged position toward the disengaged position. As the clamp foot 46 reaches the top of the barrel guide portion 90 cam surfaces 96 (FIG. 6) interact with the arm 60 of the clamp foot 46 and rotate the clamp foot 46 from the disengaged position to the retracted position. Once all clamp feet 46 have been released and are in their respective retracted positions, the speaker enclosure 10 may be removed from the ceiling panel.

Referring now to FIGS. 10-12, in some configurations, the speaker enclosure 10 may include an outer housing 170 into which the speaker support 14 can be removably installed. In these configurations, rather than installing the speaker support 14 directly into a ceiling or other panel, the outer housing 170 is installed into or within the ceiling panel, and the speaker support 14, with the speaker assembly 20 and clamp assemblies 42 coupled thereto, is then installed into the outer housing 170.

The illustrated outer housing 170 includes a generally cylindrical main body 174 having a flange region 178 formed on one end and an electrical coupling module 180 formed on another end. The flange region 178 includes a radially outwardly extending flange 182 configured for engagement with the ceiling panel, and a radially inwardly extending flange 186 to which the speaker support 14 may be secured. The outwardly extending flange 182 includes circumferentially spaced apertures 190 through which fasteners may be extended to secure the outer housing 170 to the ceiling panel. In addition or in the alternative, the outer housing 170 may be secured to the ceiling structure using hanger brackets 194 that are coupled to the main body 174 and extend upwardly beyond the outer housing 170 for attachment to the ceiling structure via fasteners or other suitable connectors. The illustrated electrical coupling module 180 includes quick-connect electrical terminals 198 for connection to a source of audio signals, although screw terminals or other methods of electrical connection may also be used. The coupling module 180 includes a plug assembly (not shown) that extends into the interior of the outer housing for connection with the speaker assembly 20.

For installations making use of the outer housing 170, unlike the configurations of FIGS. 1-8, the speaker support 14 does not include a speaker can 18 that defines the speaker enclosure volume. Rather, the back side of the speaker assembly 20 remains exposed. To install the speaker support 14 into the outer housing 170, the speaker support 14 is inserted into the opening defined by the inwardly extending flange 186. The handles 86 and clamp assemblies 42 may then be operated in the manner described above to secure the speaker support 14 to the outer housing 170 by clamping the inwardly extending flange 186 of the outer housing 170 between the mounting flange 26 and the clamp feet 46 of the speaker support 14. Similarly, the speaker support 14 may be easily and quickly removed from the outer housing 170 in the manner described above to service or replace the speaker assembly 20 as needed.

In the illustrated configuration, when the speaker support 14 is installed within the outer housing 170, the outer housing 170, the speaker support 14, the speaker assembly 20, the handles 86, and the resilient seals 142 cooperate to define a sealed speaker enclosure volume 202. In other configurations, one or more of the outer housing 170, the speaker support, or the handles 170 may be provided with one or more ports to define a ported speaker enclosure volume. Regardless of whether the resulting speaker enclosure volume is sealed or ported, in the configuration shown in FIGS. 10-12, at least the clamp feet 46 of the clamp assemblies 42 are located inside the speaker enclosure volume 202 and share the speaker enclosure volume 202 with the speaker assembly 20, while the hanger brackets 194 and electrical terminals 198 are located outside of the speaker enclosure volume 202 (see FIG. 12).

Relative to the configuration of FIGS. 1-8, for a given speaker assembly diameter and installation depth, the configuration of FIGS. 10-12 can be adapted to provide a larger speaker enclosure volume 202, which may provide improved acoustic characteristics. In configurations utilizing the outer housing 170 and having a sealed speaker enclosure volume 202, by limiting fluid communication through the openings in the mounting flange 26, the resilient seals 142 contribute to overall sound quality by maintaining the integrity of the sealed speaker enclosure volume 202. If a ported speaker enclosure configuration is desired, by limiting fluid communication through the openings 88, 126 in the mounting flange 26, the resilient seals 142 allow the designer to size and locate the port or ports to achieve the desired acoustic characteristics without having to also account for flow through the openings 88, 126.

Those skilled in the art will appreciate that the desired volume of the speaker enclosure and whether the speaker enclosure should be sealed or ported are matters of design choice that may be driven by a variety of factors. Regardless of a designer's specific choices in this regard, by utilizing handles 86 with resilient seals 142 that limit fluid communication between the interior of the enclosure volume and the exterior of the enclosure volume, the speaker enclosures 10 described herein improve the audio system designer's ability achieve a desired acoustic result. The snug fit of the seals 142 within the recesses 130 also provides a high-quality tactile feel during installation of the speaker support 14, and functions to reduce unwanted rattling or movement of the handles 86 and actuator rods 78 during operation of the speaker assembly 20, thereby enhancing overall acoustic performance.

1. A ceiling mountable speaker enclosure comprising:
a speaker support at least partially defining the speaker enclosure and including a mounting flange extending outwardly from the speaker support, the mounting flange defining an outwardly facing side, an inwardly facing side, and a plurality of flange openings extending through the mounting flange and affording fluid communication between the inwardly facing side and the outwardly facing side; and,
a clamp assembly coupled to the mounting flange and including a clamp foot and an actuator rod having a first end engageable with the clamp foot and a second end including a handle, the handle including a resilient seal and being operable to afford movement of the clamp foot relative to the mounting flange, the handle having a stowed position in which the resilient seal engages the mounting flange to limit fluid communication via the plurality of flange openings between the inwardly facing side and the outwardly facing side of the mounting flange.

2. The ceiling mountable speaker enclosure of claim 1, wherein the mounting flange defines a recess that opens toward the outwardly facing side, wherein the plurality of flange openings are positioned within the recess, and wherein when the handle is in the stowed position the handle is at least partially received within the recess.

3. The ceiling mountable speaker enclosure of claim 2, wherein the recess defines a perimeter wall having a first perimeter profile, and wherein the resilient seal has second perimeter profile that corresponds to the first perimeter profile such that when the handle is in the stowed position the resilient seal is compressed against the perimeter wall.

4. The ceiling mountable speaker enclosure of claim 1, wherein the clamp assembly includes a release lever that is operable to release the clamp foot for movement from an engaged position toward a disengaged position, and wherein the release lever extends from the inwardly facing side through one of the plurality of flange openings to the outwardly facing side.

5. The ceiling mountable speaker enclosure of claim 4, wherein the handle defines a handle opening, wherein the resilient seal extends into and surrounds the handle opening, and wherein when the handle is in the stowed position the release lever extends into the handle opening and engages the resilient seal to limit fluid communication through the handle opening.

6. The ceiling mountable speaker enclosure of claim 4, wherein when the handle is in the stowed position, the handle engages the release lever to prevent operation of the release lever.

7. The ceiling mountable speaker enclosure of claim 1, wherein the speaker support includes a speaker assembly, the speaker enclosure further comprising an outer housing into which the speaker support is removably installable, wherein when the speaker support is installed within the outer housing, the mounting flange and the clamp foot cooperate to secure the speaker support within the outer housing, and the outer housing, the speaker support, the speaker assembly, the handle, and the resilient seal cooperate to define a speaker enclosure volume.

8. The ceiling mountable speaker enclosure of claim 7, wherein the clamp foot is located inside the speaker enclosure volume.

9. The ceiling mountable speaker enclosure of claim 1, wherein the clamp foot includes an arm having a top surface and a first contact surface spaced a first distance from the top surface, the speaker enclosure further comprising a clamp foot extension detachably securable to the clamp foot and having a second contact surface, wherein when the clamp foot extension is secured to the clamp foot the second contact surface is spaced a second distance from the top surface that is greater than the first distance.

10. A ceiling mountable speaker enclosure comprising:
a speaker support at least partially defining the speaker enclosure and including a speaker assembly and a mounting flange, the mounting flange defining an outwardly facing side, an inwardly facing side, and a flange opening extending through the mounting flange and affording fluid communication between the inwardly facing side and the outwardly facing side;
a clamp assembly coupled to the mounting flange and including a clamp foot and an actuator rod having a first end engageable with the clamp foot and a second end including a handle, the handle including a resilient seal and being operable to afford movement of the clamp foot relative to the mounting flange, the handle having a stowed position in which the resilient seal engages the mounting flange to limit fluid communication via the flange opening between the inwardly facing side and the outwardly facing side of the mounting flange; and,
an outer housing into which the speaker support is removably installable, wherein when the speaker support is installed within the outer housing, the mounting flange and the clamp foot cooperate to secure the speaker support within the outer housing, and the outer housing, the speaker support, the speaker assembly, the handle, and the resilient seal cooperate to define a speaker enclosure volume.

11. The ceiling mountable speaker enclosure of claim 10, wherein the outer housing includes hanger brackets for supporting the outer housing, and electrical terminals connectable with an audio source, and wherein when the speaker support is installed within the outer housing, the hanger brackets and electrical terminals are located outside of the speaker enclosure volume.

12. The ceiling mountable speaker enclosure of claim 10, wherein when the speaker support is installed within the outer housing the clamp foot is positioned inside the speaker enclosure volume.

13. The ceiling mountable speaker enclosure of claim 10, wherein the mounting flange defines a recess that opens toward the outwardly facing side, wherein the flange opening is positioned within the recess, and wherein when the handle is in the stowed position the handle is at least partially received within the recess.

14. The ceiling mountable speaker enclosure of claim 13, wherein the recess defines a perimeter wall having a first perimeter profile, wherein the resilient seal has second perimeter profile that corresponds to the first perimeter profile, and wherein when the handle is in the stowed position the resilient seal is compressed against the perimeter wall.

15. A ceiling mountable speaker enclosure comprising:
a speaker support at least partially defining the speaker enclosure and including a mounting flange, the mounting flange defining an outwardly facing side, an inwardly facing side, and a plurality of flange openings extending through the mounting flange and affording fluid communication between the inwardly facing side and the outwardly facing side; and, a clamp assembly coupled to the mounting flange and including a clamp foot and an actuator rod having a first end engageable with the clamp foot and a second end including a handle, the handle including a resilient seal and being operable to afford movement of the clamp foot relative to the mounting flange from a disengaged position toward an engaged position, the handle having a stowed position in which the resilient seal engages the mounting flange to limit fluid communication via the plurality of flange openings between the inwardly facing side and the outwardly facing side of the mounting flange, the clamp assembly further including a release lever that is operable to release the clamp foot for movement from the engaged position toward the disengaged position, and wherein the release lever extends from the inwardly facing side through one of the plurality of flange openings to the outwardly facing side.

16. The ceiling mountable speaker enclosure of claim 15, wherein the mounting flange defines a recess that opens toward the outwardly facing side, wherein the plurality of flange openings are positioned within the recess, and wherein when the handle is in the stowed position the handle is at least partially received within the recess.

17. The ceiling mountable speaker enclosure of claim 16, wherein the recess defines a perimeter wall having a first perimeter profile, wherein the resilient seal has second perimeter profile that corresponds to the first perimeter profile, and wherein when the handle is in the stowed position the resilient seal is compressed against the perimeter wall.

18. The ceiling mountable speaker enclosure of claim 15, wherein the handle defines a handle opening, wherein the resilient seal extends into and surrounds the handle opening, and wherein when the handle is in the stowed position the release lever extends into the handle opening and engages the resilient seal to limit fluid communication through the handle opening.

19. The ceiling mountable speaker enclosure of claim 15, wherein when the handle is in the stowed position, the handle engages the release lever to prevent operation of the release lever.

20. The ceiling mountable speaker enclosure of claim 15, wherein the speaker support includes a speaker assembly, the speaker enclosure further comprising an outer housing into which the speaker support is removably installable, wherein when the speaker support is installed within the outer housing, the mounting flange and the clamp foot cooperate to secure the speaker support within the outer housing, the outer housing, the speaker support, the speaker assembly, the handle, and the resilient seal cooperate to define a speaker enclosure volume, and at least the clamp foot of the clamp assembly is located inside the speaker enclosure volume.
